(19) United States
(12) Patent Application Publication
(10) Pub. No.: US 2002/0143922 A1
(43) Pub. Date: Oct. 3, 2002

(54) Relay server and relay system

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/114,720

(22) Filed: Apr. 1, 2002

(30) Foreign Application Priority Data
Apr. 3, 2001 (JP) 2001-104152
Jul. 12, 2001 (JP) 2001-212002
Jul. 12, 2001 (JP) 2001-212254

(51) Int. Cl. G06F 15/173

(52) U.S. Cl. 709/223; 709/225

(57) ABSTRACT

A relay server for realizing a connection between a device at the Internet side and a terminal within a local system, and enabling various settings from the terminal at the time of the login from the terminal within the local system. When carrying out the communication between a first terminal and a second terminal, the first terminal and the second terminal make the login to the relay server, and secure the communication path in advance. Then, the relay server carries out the communication with the first terminal and the second terminal, and by relaying the communication between the two terminals, the communication between the first and second terminals is realized. When making the login to the relay server, the first and second terminals designate various attributes information. The relay server carries out various relay processing by following the designated attributes information.

### CROSS REFERENCES TO RELATED APPLICATIONS

This application claims priority under 35 USC 119 of Japanese Patent Application Nos. 2001-104152, 2001-212002, and 2001-212254 filed in JPO on Apr. 3, 2001, Jul. 12, 2001, and Jul. 12, 2001, respectively, the entire disclosures of which are incorporated herein by reference.

### BACKGROUND OF THE INVENTION

1. Field of the Invention

The present invention relates to a relay server for enabling communication between network devices by carrying out the communication with a plurality of network devices and relaying the communication between a certain network device and another network device, and also to a relay system including such a relay server.

2. Description of the Related Art

FIG. 8 is a view illustrating an example of a general system using the Internet. In FIG. 8, the reference numerals 1, 2 designate local systems, 3 the Internet, 11, 12, 21, 22 terminals, 13, 23 gateways, and 14, 24 LANs (Local AreaNetwork). The terminal 11, the terminal 12, the gateway 13 and the like are connected by the LAN 14 to form the local system 1. The gateway 13 is connected to the Internet 3 along with the LAN 14, and the Internet can be used from various network apparatus, such as the terminal 11, and the terminal 12 on the LAN 14. Moreover, as in the same manner, the terminal 21, the terminal 22, the gateway 23 and the like are connected by the LAN 24 to form the local system 2. The gateway 23 is connected to the Internet 3 along with the LAN 24, and the Internet can be used from various network apparatus, such as the terminal 21 and the terminal 22 on the LAN 24. Moreover, other various apparatus can be connected by the LAN 14 within the local system 1, and by the LAN 24 within the local system 2.

According to such a system, normally, one or a plurality of global IP addresses are assigned to the local system 1 and the local system 2. However, the global IP address is not assigned to each of the network apparatus within the local system 1 and the local system 2. A private IP address is assigned to each network apparatus within each of the local system 1 and the local system 2, and by using a function such as NAT (Network Address Translation) or IP masquerade by the gateway 13 and the gateway 23, the private IP address is converted into the global IP address. By using the gateway 13 and the gateway 23 having such a function for converting the IP address, for example, in the local system 1, the terminal 11 and the terminal 12 use the Internet 3 via the gateway 13. In addition, in the local system 2, the terminal 21 and the terminal 22 use the Internet 3 via the gateway 23.

Moreover, the gateway 13, the gateway 23, other network devices and the like are provided with a function such as a firewall or a proxy server, and a system has been used in which each terminal uses the Internet 3 via these devices such as the gateways. Furthermore, the safety in the system has been improved.

For example, when attempting to access the terminal 11 within the local system 1 from the Internet 3, the global IP address of the gateway 13 can be learned. However, the private IP address of the terminal 11 cannot be learned. Therefore, under the general connection method, the terminal 11 cannot be accessed from the outside of the local system 1. Moreover, there are cases in which a site which accepts the access is limited by the firewall function or the like of the gateway 13. In addition, the same limitation of the access is applied to the terminal 12, and also applied to the terminal 21, and the terminal 22 within the local system 2.

Furthermore, the terminal 11 or the terminal 12 within the local system 1, and the terminal 21 or the terminal 22 within the local system 2 are generally provided with only client functions, and are not provided with functions of a server for accepting information from other network apparatus. Therefore, unless accessing other network apparatus from the terminal 11, the terminal 12, the terminal 21, and the terminal 22, the information cannot be transmitted to these terminals from other network apparatus.

### SUMMARY OF THE IVENTION

A first object of the present invention is to provide a relay server and a relay system for enabling the connection to a terminal within a local system from the Internet, or the connection between the terminals within different local systems, and enabling various settings from the terminal at the time the login is made from the terminal within the local system.

A second object of the present invention is to provide a relay server for realizing a relay system wherein cipher communication can be carried out between the terminals within different local systems.

According to one aspect of the present invention, there is provided a relay server including communication means for carrying out the communication with a plurality of network devices, and control means for relaying the communication between the network devices by using the communication means. The control means starts the communication with the network device by the login demand from the network device, and also carries out relay processing by following attributes information designated by the network device when the login is demanded. Under such structure, by the login to the relay server from the network device, and by relaying the communication of the network device which is in the login state, for example, even in the case the network device is a device within a local system, the communication from the Internet to the network device can be realized. Moreover, when the network device makes the login to such a relay server, the attributes information can be designated from the network device. Therefore, the relay server can carry out various relay processing corresponding to the attributes information designated from the network device.

Preferably, by the attributes information, it is possible to designate, to the relay server, whether or not to notify, to other users, the fact that the network device which has designate the attribution information has made the login. For example, if the designation that the fact should not be notified to the other users, it is possible to prevent a third party from knowing the fact, and avoid receiving a connection demand from the unspecified other users.

Preferably, by the attributes information, it is possible to designate the information concerning data receiving of the network device which designate the attributes information. Therefore, it can be declared that the network device can receive data, or that the network device can only transmit data. Furthermore, thereby, data receiving ability of the network device can be declared in advance.

Preferably, by the attributes information, it is possible to designate the information concerning authentication. In the case in which the information concerning the authentication is designated, the network device and/or the relay server is constructed such that the authentication is performed at the time other users make a connection demand to the network device which has designated the authentication. If the authentication succeeds, the connection is carried out. Accordingly, it is possible to limit users which can be accepted, and improve the security. Furthermore, the relay server may hold an algorism for the authentication, and therefore, the network device may have simpler structure

Preferably, by the attributes information, it is possible to designate other parties which can carry out communication with the network device which has designated this attribute information. Accordingly, it is possible to designates the parties with which the communication is carried out, and set conditions to the parties. Therefore, the communication parties can be limited so as to prevent the third party from making access illegally.

According to another aspect of the present invention, the abovementioned authentication can be carried out by the network device which is connected to the relay server. That is, a first network device is capable of carrying out the authentication of a second network device by following the data relayed by the relay server from the second network device. In this case, the relay server can relay the data between the first network device and the second network device by following the connection demand from the second network device to the first network device. Even with such structure of the network device and/or the relay server, the users whose connection demands can be accepted can be limited, and the security can be improved. Moreover, the first network device is capable of carrying out the authentication by using each authentication method corresponding to each application to be used, and for example, the authentication method can be changed per each application.

According to another aspect of the present invention, there is provided a relay server including communication means for carrying out the communication with a plurality of network devices, and control means for relaying the communication between the network devices by using the communication means. The control means indicates the cipher communication to another network device which demanded the connection to the network device, when the cipher communication is indicated from the network device, and the connection is demanded from the network device to other network device.

With the above-mentioned structure of the network device and/or the relay server, by making the login to the relay server from the network device, and by relaying the communication of the network device which is in the login state, for example, even in the case the network device is a device within the local system, the communication can be realized from the Internet to the network device. In addition, by carrying out the cipher communication not only between the network device which demanded the cipher communication and the relay server, but also between the relay server and the network device of the destination, the cipher communication can be realized between the network devices.

According to another aspect of the present invention, the cipher communication can be carried out under relay protocol level or application level. When carrying out the cipher communication under the relay protocol level, the protocol itself can be encrypted to carry out the communication. Further, the indication of the cipher communication can be set in advance, or carried out at the time the network device makes the login to the relay server. In this case, the indication of whether or not to carry out the cipher communication can be notified to other network devices.

Additional objects, aspects, benefits and advantages of the present invention will become apparent to those skilled in the art to which the present invention pertains from the subsequent detailed description and the appended claims, taken in conjunction with the accompanying drawings.

### BRIEF DESCRIPTION OF THE DRAWINGS

FIG. 1 is a block diagram showing a communication system including a relay server according to an embodiment of the present invention;

FIG. 2 is a sequence diagram showing an example of a communication procedure in the communication system including the relay server shown in FIG. 1;

FIG. 3 is a block diagram showing a communication system including a relay server according to another embodiment of the present invention;

FIG. 4 is a (partial) sequence diagram showing an example of a communication procedure in the communication system including the relay server shown in FIG. 3;

FIG. 5 is a (partial) sequence diagram showing an example of a communication procedure in the communication system including the relay server shown in FIG. 3;

FIG. 6 is a (partial) sequence diagram showing another example of a communication procedure in the communication system including the relay server shown in FIG. 3;

FIG. 7 is an illustration showing a case in which encrypting is carried out under the application level in another example of the communication system including the relay server shown in FIG. 3; and

FIG. 8 is a block diagram showing an example of a general system using the Internet.

### DETAILED DESCRIPPTION OF THE INVENTION

### First Embodiment

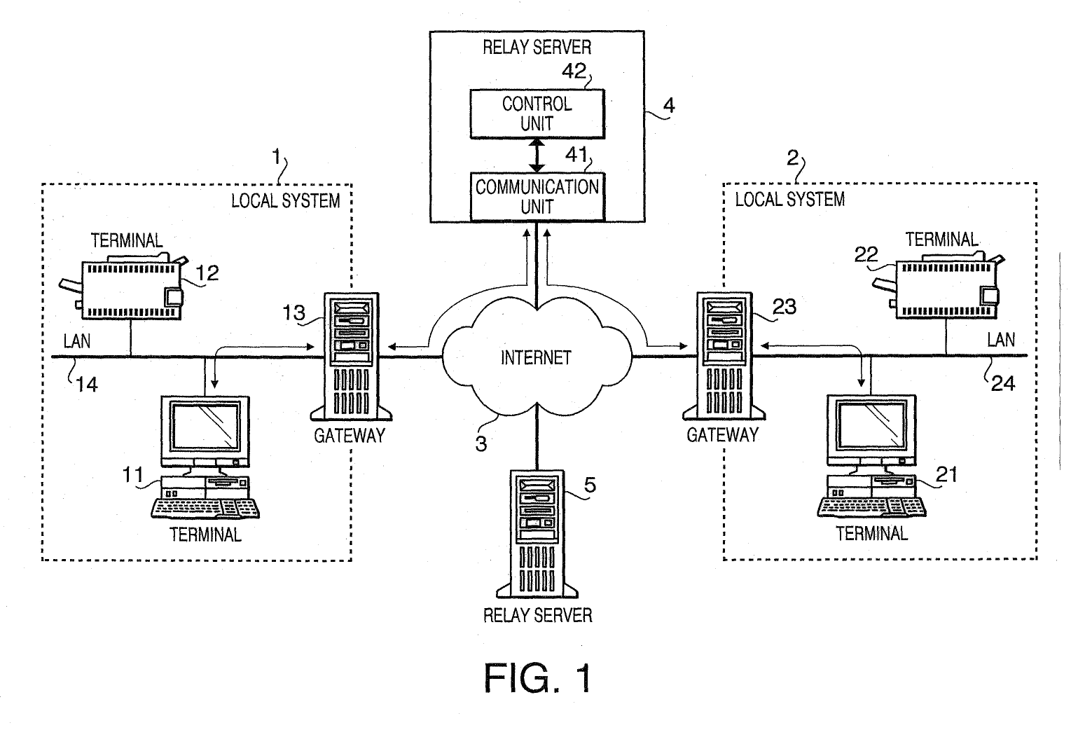

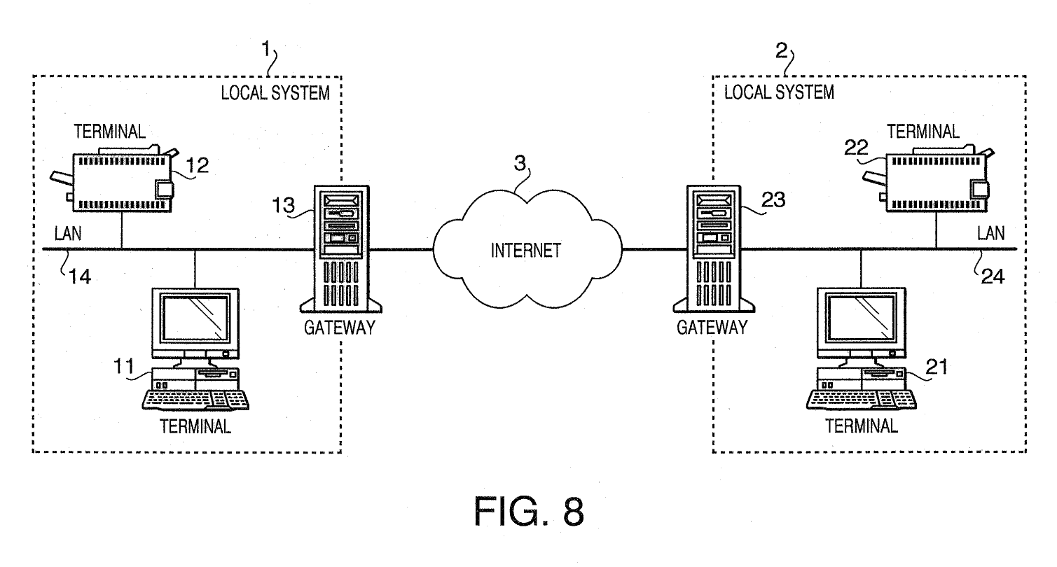

A first embodiment of the present invention will be described with reference to the drawings. In FIG. 1, the same reference numerals are applied to the same parts as the parts in FIG. 8, and overlapping description will be omitted. The reference numerals 4, 5 designate relay servers, 41 a communication unit, and 42 a control unit. The relay server 4 is connected to the Internet 3, and has a global IP address. By using the global IP address, the relay server 4 can carry out the communication with various network apparatus via the Internet 3.

The relay server 4 can be provided with the communication unit 41, the control unit 42, or the like. The communication unit 41 is capable of carrying out the communication with a plurality of network devices via the Internet 3.

The control unit 42 receives a login demand transmitted from the network device via the communication unit 41, and secures a communication path by maintaining the connection with the network device. Moreover, at the time of the login demand, the control unit 42 receives designation of various attributes information transmitted from the network device, and carries out the processing of the login by following the attributes information. The attributes information and the processing of the login are to be described later on. Furthermore, when the login demand is received, and the communication path is secured in the manner stated above, the communication path is continued until the logout. When the control unit 42 receives connection demand information from the network device which is connected capable of carrying out the communication, by following the connection demand information, the control unit 42 relays the data forwarding between the network device which is connected capable of carrying out the communication and the network device which demanded the connection.

For example, under the condition in which each of the terminal 11 and the terminal 21 are connected such that the communication can be carried out, and the communication path is secured, when the control unit 42 receives the connection demand information with the terminal 21 from the terminal 11, the data forwarding is carried out with the terminal 11, the data forwarding is also carried out with the terminal 21, and the communication between the terminal 11 and the terminal 21 is carried out substantially. Moreover, it is possible to secure a plurality of connections with one network device, and the communication with a plurality of network devices can be carried out by using a plurality of connections.

In this case, the terminal 11 is the network device within the local system 1, and the terminal 21 is the network device within the local system 2. The connection can be made from the relay server 4 to the gateway 13 and the gateway 23 However, the connection cannot be made from the relay server 4 to the terminal 11 and the terminal 21. As in the manner stated above, the communication cannot be carried out directly between the terminal 11 and the terminal 21. However, by using the global IP address of the relay server 4, the connection can be made from the terminal 11 to the relay server 4 via the gateway 13, and from the terminal 21 to the relay server 4 via the gateway 23. Therefore, by demanding the login from the terminal 11 or the terminal 21 to the relay server 4, the communication can be carried out in both directions between the relay server 4 and the terminal 11 or the terminal 21 which demanded the login.

When the communication can be carried out in both directions between the relay server 4 and the terminal 11, and between the relay server 4 and the terminal 21, in the case the relay server 4 receives the communication demand from the terminal 11 to the terminal 21, the relay server 4 receives the data sent from the terminal 11, and transmits the received data to the terminal 21. Accordingly, the data forwarding is carried out from the terminal 11 to the terminal 21. Moreover, on the other hand, the relay server 4 can receive the data sent from the terminal 21, and transmit the received data to the terminal 11. As in the manner stated above, the communication can be realized between the terminal 11 and the terminal 21.

Further, the relay server 5 shown in FIG. 1 has the structure similar to that of the relay server 4. By securing the communication path between the relay server 4 and the relay server 5, the communication can be realized between the network device which made the login to the relay server 4 and the network device which made the login to the relay server 5. Moreover, still more relay servers can exist on the Internet 3, and a relay server for relaying the communication between the relay servers can be provided. The number of relay servers existing on the Internet can vary, and at least one relay server is required to exist.

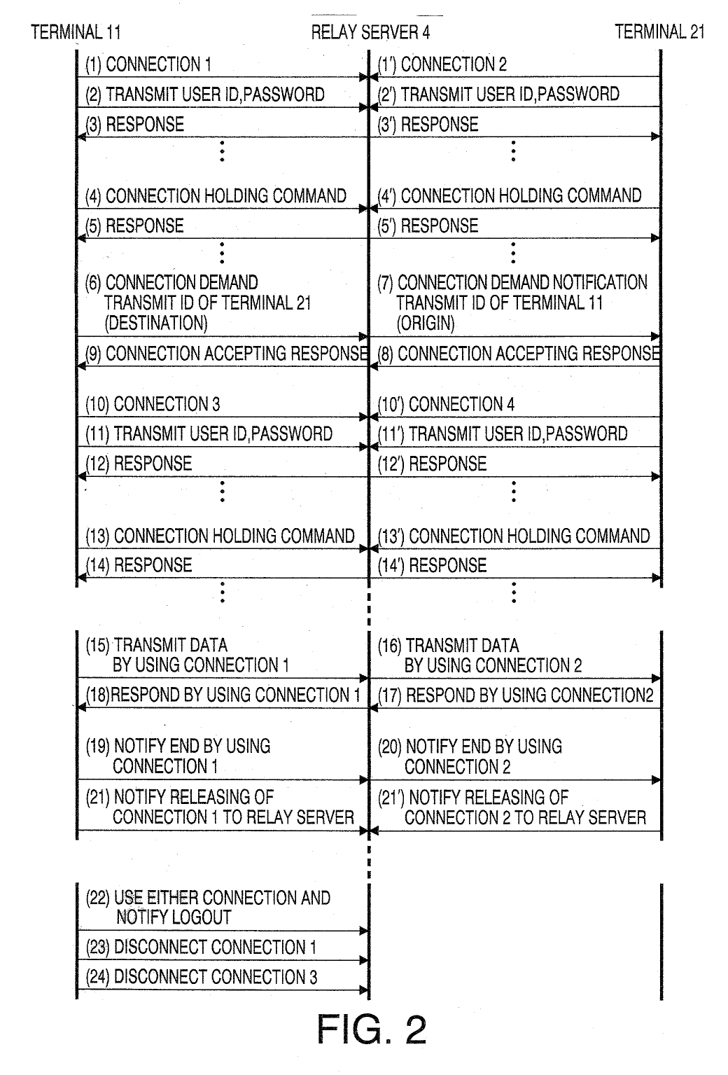

The communication procedure shown in FIG. 2 is carried out by using TCP/IP (Transmission Control Protocol/Internet Protocol). For example, connection with the relay server 4, continuation of the connection, a connection demand to the terminal, data forwarding to the terminal, an end of connection with the terminal, and an end of connection with the relay server are carried out. In the example shown in FIG. 2, the communication is carried out between the terminal 11 within the local system 1 and the terminal 21 within the local system 2, which are shown in FIG. 1. The terminal 11 and the terminal 21 are registered as users to the relay server 4. For example, user IDs or passwords of these terminals are registered.

For example, after being started or by the instruction of an operator, in (1), the terminal 11 makes connection to the relay server 4 via the gateway 13, makes the login, and establishes the TCP/IP connection (connection 1) with the relay server 4. Since the terminal 11 is the network device within the local system 1, the communication cannot be carried out directly from the relay server 4. However, by the login from the terminal 11 which is a client, the connection can be made to the relay server 4. Since the TCP/IP connection is capable of carrying out the data communication in both directions, the communication can be carried out from the terminal 11 to the relay server 4, or from the relay server 4 to the terminal 11.

After the connection 1 is established, in (2), the terminal 11 transmits the user ID and the password to the relay server 4. The relay server 4 checks whether or not the received user ID and the password are held as connection information in the control unit 42, and carries out the authentication of the terminal 11. By the authentication, the connection with an unspecified third party can be avoided, and the safety can be maintained. In the case of a failure in the authentication in that the connection information is not registered or in that the password is incorrect, the relay server 4 carries out a negative response to the terminal 11, or disconnects the connection 1. In the case the authentication succeeds, the terminal 11 carries out a positive response to the relay server 4 in (3).

In addition, during the login processing up to this stage, various attributes information can be designated, such as the information concerning the notification of the completion of the login, and the information concerning the data receiving, and the information concerning the destination to which the connection can be made. The attributes information may be transmitted to the relay server 4 along with the user ID, the password or/and the like, or after the positive response from the relay server 4, the transmitting of the attributes information may be carried out separately.

When the processing of the login is completed as in the manner stated above, the terminal 11 carries out control so as to continue the connection 1 until the connection 1 is disconnected. Therefore, the terminal 11 transmits a connection holding command to the relay server 4 periodically in (4), and the response of confirmation is obtained from the relay server 4 in (5). In this manner, the connection is held in this manner, and it is carried out to confirm that the relay server 4 is working normally.

As in the same manner, the terminal 21 makes connection to the relay server 4 via the gateway 23 in (1′), makes the login, and establishes the TCP/IP connection (connection 2) with the relay server 4. Since the terminal 21 is also a network device within the local system 2, the communication cannot be carried out directly from the relay server 4. However, the connection can be made to the relay server 4 by the login from the terminal 21 which is a client. By the connection 2, the communication can be carried out from the terminal 21 to the relay server 4, or from the relay server 4 to the terminal 21.

After the connection 2 is established, the terminal 21 transmits the user ID and password to the relay server 4 in (2′). The relay server 4 checks whether or not the received user ID and the password are held as the connection information in the control unit 42, and carries out the authentication of the terminal 21. In the case of a failure in the authentication in that the connection information is not registered or in that the password is incorrect, the relay server 4 carries out the negative response to the terminal 21, or disconnects the connections 2. In the case the authentication succeeds, the relay server 4 carries out the positive response in (3′). Moreover, during the login processing up to this stage, various attributes information can be designated. The attributes information may be transmitted to the relay server 4 along with the user ID and the password, or the like, or after the positive response from the relay server 4, the transmitting of the attributes information may be carried out separately.

When the processing of the login is completed in the manner stated above, until the connection 2 is disconnected, the connection 2 is controlled to be continued. Therefore, the terminal 21 transmits the connection holding command to the relay server 4 periodically in (4′), and the response of the confirmation is obtained from the relay server 4 in (5′). In this manner, the connection is held, and the confirming that the relay server is working normally is made.

Further, the connection between the terminal 11 and the relay server 4, and the connection between the terminal 21 and the relay server 4 may be carried out at any time so long as these connections are made before the communication by both terminals 11 and 21 is carried out. Furthermore, it is necessary for the connections with the relay server 4 to be continued until the communication by the terminals is carried out.

When a demand is generated to the effect that the connection is to be made from the terminal 11 to the terminal 21, the terminal 11 designates, to the relay server 4, the user ID of the terminal 21 with which the terminal 11 wants to make connection, and carries out the connection demand in (6). The user ID of the terminal 21 which is to be the destination can be designated by any methods. For example, the user ID can be obtained in advance. Alternatively, the user ID can be designated by making confirmation by using a list or the like of users which are in a login state. This list may be obtained from the relay server 4. When the terminal 21 corresponding to the designated user ID is not in the login state, the relay server 4 returns an error message to the terminal 11. Furthermore, in the case the terminal 21 is in the login state, in (7), the relay server 4 transmits, to the terminal 21, the connection demand notification including the information that there is a connection demand to the terminal 21, and the user ID of the terminal 11 which is demanding the connection.

The terminal 21 stores that the connection used in the transmission of the connection demand notification is being used for the connection with the terminal 11, and in (8), the terminal 21 returns the response that the connection can be accepted. Further, when rejecting the connection, the terminal 21 returns an error message. The relay server 4 returns the response from the terminal 21 to the terminal 11 in (9). In the case the response from the terminal 21 is the response for accepting the connection, the relay server 4 stores that the connection 1 is to be used in the communication with the terminal 11, and the connection 2 is to be used in the communication with the terminal 21. Moreover, in the case of receiving the response that the connection can be accepted, the terminal 11 which received the response from the terminal 21 stores that the connection in use (connection 1) is to be used for the communication with the terminal 21.

After confirming that the communication is to be carried out between the terminal 11 and the terminal 21 as in the manner stated above, the data is transmitted actually after (15). Further, in the example shown in FIG. 2, after it is determined that the communication is to be carried out between the terminal 11 and the terminal 21, both the terminal 11 and the terminal 21 establish new TCP/IP connections with the relay server 4 respectively in order to accept the connection demand from another network apparatus, or in order to carry out the connection demand to another network apparatus. That is, the terminal 11 makes login to the relay server 4, and establishes the TCP/IP connection (connection 3) with the relay server 4 in (10), and the terminal 11 transmits the user ID and the password to the relay server 4 in (11). The relay server 4 carries out the authentication of the terminal 11 by the received user ID and password, and returns the response in (12). After that, the terminal 11 transmits the connection holding command to the relay server 4 periodically in (13) to maintain the connection 3, and the relay server 4 returns the response to the terminal 11 in (14). As in the same manner, the terminal 21 makes login to the relay server 4, and establishes the TCP/IP connection (connection 4) with the relay server 4 in (10′), and the terminal 21 transmits the user ID and the password to the relay server 4 in (11′). The relay server 4 carries out the authentication of the terminal 21 by the received user ID and password, and returns the response in (12′). After that, the terminal 21 transmits the connection holding command to the relay server 4 periodically in (13′) to maintain the connection 4, and the relay server 4 returns the response to the terminal 21 in (14′).

Further, in the case the new TCP/IP connection is established in such a manner, the attributes information relating to the connection can be designated. The attributes information designated at this time may be different from the attributes information of the previous connection. Moreover, the connection at this time may inherit the attributes of the previous connection as it is without designating the attributes information, or the designation that the attributes information of the previous connection should be inherited can be made by the attributes information.

However, in the case it is not necessary to reserve such vacant connections, the processes (10) to (14) or the processes (10′) to (14′) are not necessary. In addition, in the case a plurality of connections have been already secured, these processes are not necessary to be carried out.

When confirming that the communication is to be carried out between the terminal 11 and the terminal 21 in (6) to (9), the terminal 11 transmits, to the relay server 4, the data for the terminal 21 through the connection 1 in (15). The relay server 4 receives the data from the terminal 11, and transmits the received data to the terminal 21 through the connection 2 in (16). The terminal 21 receives the data from the terminal 11, which was transmitted from the relay server 4 through the connection 2, and in (17), the terminal 21 transmits, to the relay server 4, the response for the terminal 11. The relay server 4 receives the response to the terminal 11 from the terminal 21, and in (18), the relay server 4 transmits, to the terminal 11, the received response through the connection 1.

As in the manner stated above, by using the connection 1 between the terminal 11 and the relay server 4, and the connection 2 between the terminal 21 and the relay server 4, and relaying the data by the relay server 4, the communication can be carried out between the terminal 11 and the terminal 21. Further, the data forwarding from the terminal 11 to the terminal 21 in (15) to (18) can be repeated several times. Moreover, the data forwarding can be carried out from the terminal 21 to the terminal 11.

When the data forwarding is completed between the terminal 11 and the terminal 21, end notification is carried out from the terminal 11 or the terminal 21. In this example, it is assumed that the end notification is carried out from the terminal 11, and the terminal 11 transmits the end notification for the terminal 21 to the relay server 4 through the connection 1 in (19). The relay server 4 transmits, to the terminal 21, the end notification for the terminal 21 which was received from the terminal 11, through the connection 2 in (20). The terminal 11 which transmitted the end notification also transmits releasing notification to the relay server 4 in (21). The releasing notification indicates that the connection 1 has become vacant. Moreover, the terminal 21 which received the end notification transmits the releasing notification to the relay server 4 in (21′), indicating that the connection 2 has become vacant. Accordingly, the relay server 4 stores that the connection 1 and the connection 2 are not used in the communication between the terminal 11 and the terminal 21, and have become vacant. Further, in this example, the response to the end notification is not carried out, but the response may be sent back.

The connection 1 and the connection 2 which were released in such a manner are maintained between the terminal 11 and the relay server 4, and between the terminal 21 and the relay server 4 by transmitting the connection holding command and the response periodically as shown in (4), (5), or (4′), (5).

Further, the connection 1 and the connection 3 are secured between the terminal 11 and the relay server 4 at this time. As in the same manner, the connection 2 and the connection 3 are secured between the terminal 21 and the relay server 4. These connections 1 and 3 may be maintained. When releasing the connection 1 and the connection 2, these connections may be disconnected. Of course, the connection 1 and the connection 2 may be continued, and the connection 3 and the connection 4 may be disconnected.

In the case the terminal 11 shuts a power source, or in the case the connection to the relay server 4 is ceased, in (22), the terminal 11 notifies the logout to the relay server 4. At this time, in the case a plurality of connections are secured, the notification can be carried out through any one of the connections. Then, the terminal 11 disconnects all connections, and ends the communication. In this example, the connection 1 is disconnected in (23), and the connection 3 is disconnected in (24), and then the communication is ended. The relay server 4 receives the notification of the logout from the terminal 11, recognizes the logout of the terminal 11, and disconnects all connections (connection 1, connection 3) with the terminal 11. Further, in the case of the terminal 21, the same procedure is taken.

By carrying out the abovementioned procedure, even in the case both of or one of the terminals is the network apparatus within the local system, the communication can be carried out. Further, the procedure for carrying out the connection with the relay server 4, continuing the connection, demanding the connection to the terminal, transmitting the data to the terminal, ending the connection with the terminal, and ending the connection with the relay server can be made such that the procedure has permeability to and no influence to the command and the data exchanged by the application protocol working at an upper stage or level. In addition, the procedure can be made such that the communication can be carried out by using the existing application protocol as it is.

Next, an example of the attributes information designated by the network device at the time of the login, and the operation of the relay server following the attributes information will be described. When the network device makes the login to the relay server via the Internet 3, the attributes information can be designated as in the manner stated above. By the attributes information, it is possible to designate the information concerning the notification of the login of the network device which designated the attributes information. It is possible to designate, as the attributes information, the information concerning the notification showing the fact that the network device has made the login. The information concerning the notification can include any one of the followings:

(1) designation that the fact should be notified to all users;

(2) designation that the fact should not be notified to any user;

(3) designation that the fact should be notified to specific users; and

(4) designation that the fact should not be notified to specific users.

Here, the users are the network devices in other connections, or other relay servers. When notifying to specific users, the user to be notified can be selected. The selection of the user can be made by designating the address of the user one by one, or by designating the group of the users in accordance with a domain or the like.

When the network device makes the login, the relay server receives, by the attributes information, the designation of the information concerning the notification of the fact that the login has been made. By following the information concerning the notification, the relay server controls whether or not to disclose the login of the network device to other users. For example, when it is designated that the fact should be notified to all users, the relay server notifies, to the users being connected at this time, the fact that the network device has made the login, and also notifies the fact to the user which will make the login in the future. Further, the notification to the users includes the case in which forwarding of the information of the fact that the login has been made actively or the fact that the network device is in the login state, and also includes the notification of the fact that the connection is made in accordance with the demand from another user after the login. By notifying such a fact to all users in the manner stated above, it is possible to let other devices know the fact that the network device has made the login, or that the network device is in the login state, and in this manner, other users can make a connection demand for communication by referring to the notification.

When receiving the designation that the fact should not be notified to any user, the fact that the network device has made the login is not notified to the user being connected at the time of the login, or to the user which will make the login in the future. Accordingly, for example, it becomes possible to carry out the communication with a specific party such that other users cannot learn the fact that the network device is in the login state.

When receiving the designation that the fact should be notified to specific users, the fact that the network device is in the login state is notified to the users which have been registered in advance, or to the users which have been designated together with the notification. Accordingly, the fact that the network device is in the login state can be informed to the only specific users, and the communication can be carried out. In this manner, the generation of the connection demand or the like from other users can be suppressed.

When receiving the designation that the fact should not be notified to specific users, the fact that the network device is in the login state is not notified to users which have been registered in advance, or the users designation of which has been received together with the notification. Accordingly, for example, it is possible to make the notification such that the fact that the network device is in the login state is not notified to the users from which the communication demand is not desirable to be received.

Moreover, it is possible to designate, as another attributes information, information concerning the data reception by the network device. The information concerning the data reception can include the following information:

(1) the network device is able to receive the data;

(2) the network device is unable to receive the data;

(3) the network device is able to receive the data if a certain condition is satisfied;

(4) the network device is able to receive the data only from specific users;

(5) the network device is able to receive the data only from specific users if a certain condition is satisfied;

(6) the network device is unable to receive the data only from specific users; or

(7) authentication is necessary for receiving the data.

When receiving the designation that the network device is able to receive the data, the relay server carries out the forwarding of information transmitted from other users such that the network device always receive the information transmitted from the other users. On the other hand, when receiving the designation that the network device is unable to receive the data, the relay server does not carry out the forwarding of the information transmitted from other users. Accordingly, in this case, the network device functions as an only transmitter.

In the case the relay server receives the designation that the network device is able to receive the data if a certain condition is satisfied, the condition can be set which is registered in advance, or transmitted along with the designation. As an example of the condition, there is the condition concerning the format of the data capable of being received, or in the case the data to be received is an image, the condition concerning the size of the image. By the setting of this condition, for example, the setting of the receiving ability of the network device can be carried out in advance.

When receiving the designation that the network device is able to receive the data only from specific users, the relay server carried out the forwarding of the data transmitted only from the users which have been registered in advance or have been specified at the time of receiving the designation. Accordingly, the data only from specific users can be received, and the receiving of the data from other users can be rejected.

The designation that the network device is able to receive the data only from specific users if a certain condition is satisfied is the combination of the designation that the network device is able to receive the data if a certain condition is satisfied and the designation that the network device is able to receive the data only from specific users. The relay server forwards the data to the network device only in the case the data is transmitted by the user registered in advance, or the user indicated along with the designation, and the condition for the format of the data, the size of the data, or the like are satisfied. Accordingly, the data only from the specific users and satisfying the condition can be received, and the receiving of the data from other users and the receiving of the data which cannot satisfy the condition can be rejected.

When receiving the designation that the network device is unable to receive the data only from specific users, the relay server does not forward the data transmitted from the user registered in advance, or the user indicated along with the designation. Accordingly, for example, the receiving of the data transmitted from undesirable users can be rejected. Furthermore, in this case, the condition may be set for the receiving of the data from other than the specified users.

When receiving the designation that authentication is necessary for receiving the data, apart from the authentication at the time of the login to the relay server, the transmission of the authentication information is demanded to other users that have carried out the connection demand to the network device. Then, by collating the authentication information registered in advance or transmitted along with the designation, with the authentication information received from other users that carried out the connection demand, the authentication is carried out. Only when the connection demand is permitted as a result of the authentication, the relay server relays the data transmitted from other user. As in the manner stated above, in the case of requiring the authentication when the connection is made with other network device, if such designation regarding the attributes information is declared at the time of the login, the authentication can be carried out by the relay server when the connection is demanded from other users. Further, the condition for the receiving can be set in the case the connection demand is permitted as a result of the authentication.

Further, when carrying out the authentication of other users by transmitting the authentication information to the relay server from the network device, the authentication information can be changed each time the network device makes the login. Accordingly, the security can be improved. Moreover, in the case a plurality of relay servers exist on the network, the authentication can be carried out by any one of the relay servers, but the authentication is required to be carried out by any one of the relay servers on the path for forwarding the data. For example, the authentication can be carried out by the relay server which is connected directly to the network device which demanded the authentication, or the relay server which is connected directly with the network device of other users that carried out the connection demand. Moreover, an authentication server for carrying out the authentication can exist on the network, and the relay server can access the authentication server.

The authentication when receiving the data can be carried out by the network device. In this case, when there is the connection demand from other users, the relay server carries out the connection between the network device and the other users that carried out the connection demand, and relays the data between the network device and other users. Then, the network device carries out the authentication by using the data from other users relayed by the relay server, and only in the case the authentication succeeds, the network device can continue the communication with other users. Further, the relay server can receive the indication of the attributes information from the network device, make notification that the authentication is necessary when the connection is demanded from other users, and carries out the connection after receiving the response from other users.

When carrying out the authentication by the network device in the manner stated above, for example, the authentication can be carried out at the application level. For the authentication at the application level, the authentication algorism can be used selectively per each application to be used in the network device. Moreover, it is possible for the authentication to be not carried out depending on the application. In the case of carrying out the authentication by the relay server as in the manner stated above, the authentication is to be carried out at the level of the relay protocol. However, in this case, the authentication algorism is not required to be provided in the network device, and the structure of the network device can be simplified.

As in the manner stated above, by carrying out the authentication when receiving the data, the user with which the network device accepts the connection can be limited.

Furthermore, it is possible to designate, as another attributes information, information concerning the party which can carry out communication with the network device which has notified this attributes information. Under the abovementioned information concerning the receiving of the data, even when it is designated to reject the receiving, the connection demand can be accepted, and the data can be transmitted to the origin (user) which demanded the connection. In the case the connection demand is rejected by the information concerning the party with which the communication can be carried out, both the receiving of the data from the origin which demanded the connection and the transmission of the data to the origin which demanded the connection cannot be carried out. However, the connection demand can be carried out to other users from the network device which carried out this designation.

The information concerning the party or user which can carry out the communication with the network device can include the following i nformation:

(1) the network device is able to accept connection demands from all users;

(2) the network device is able to accept connection demands from specific users;

(3) the network device is unable to accept any connection demand; or

(4) the maximum number of connections is designated.

When receiving the designation that the network device is able to accept connection demands from all users, the relay server transmits all of the connection demands from other users to the network device (for, example, (7) of FIG. 2). When receiving the designation that the network device is unable to accept any connection demand, even if the relay server receives the connection demands from other users, the relay server does not transmit the connection demands to the network device. In this case, the relay server sends back, to the transmitter of the connection demand, a response to the effect that the connection cannot be made, or the connection demand is left alone until the time limit.

When receiving the designation that the network device is able to accept connection demands from specific users, the connection demands can be received only from the parties (users) that are registered in advance or received along with the designation, and the connection demand notification can be transmitted to the network device. For the connection demand from a user other than such users, the relay server returns, to the transmitter of the connection demand, a response to the effect that the connection cannot be made, or the connection demand is left alone until the time limit.

When receiving the designation that the maximum number of connections is designated, until the number of connections reach the designated maximum number of connections, the relay server transmits the connection demand notification to the network device when receiving the connection demand. When the number of connections exceeds the maximum number of connections, and the connection demand is received from another user, the relay server returns the response to the effect that the connection cannot be made to the transmitter of the connection demand, or the connection demand is left alone until the time limit. Accordingly, the receiving of the connection demand exceeding the ability of the network device can be prevented. Moreover, for example, by suppressing the maximum number of connections, the connection for transmission can be secured within the ability of the network device.

In the abovementioned examples, three kinds of the attributes information are described. However, the present invention is not limited to such cases, and for example, various attributes information can be designated when the network device makes the login to the relay server. Moreover, it is also possible to combine them appropriately and to combine the abovementioned example with another attributes information. For example, it is possible to combine the information concerning the notification at the time of the login with the information concerning the receiving of the data or the information concerning the user which can carry out the communication with the network device. Moreover, the designation can be made to all of or a part of the information concerning the receiving of the data, the information concerning the user which can carry out the communication, and the like, that is, it is possible to determine whether or not to notify all of or part of the information to all users at the time of the login, or whether or not to notify all of or part of the information to the specific users at the time of the login.

Moreover, the network device and the relay server can be constructed such that the abovementioned attributes information can be designated to the relay server at the time the network device makes the login, or/and the attributes information can be changed to the relay server from the network device even after the connection has been already started.

### Second Embodiment

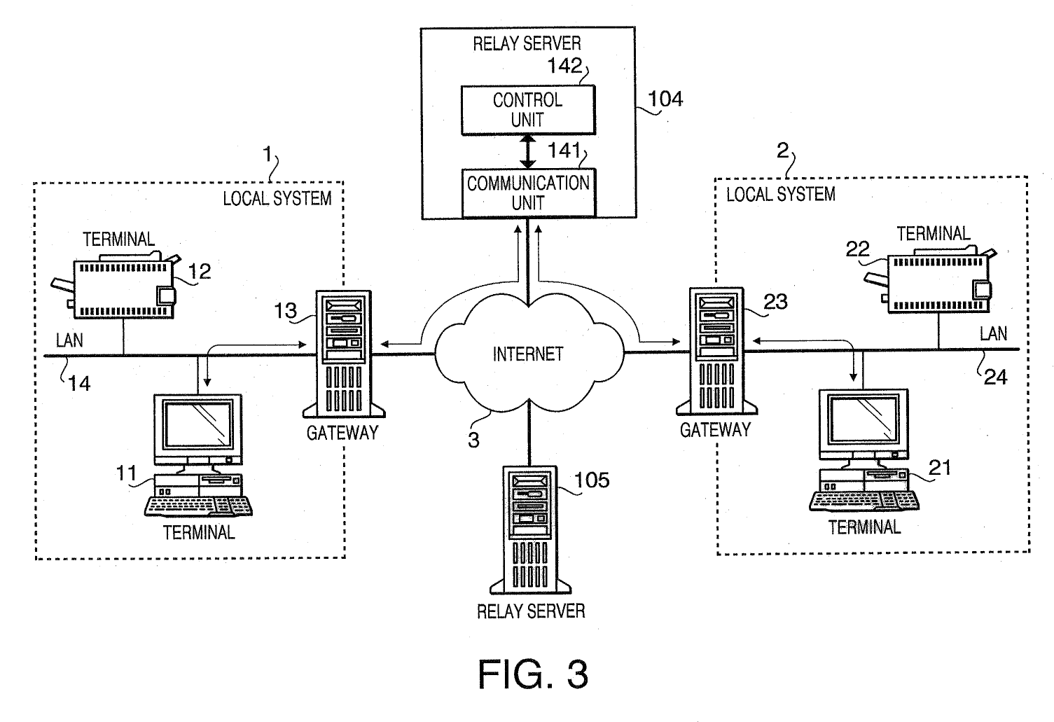

A second embodiment of the present invention will be described with reference to the drawings. In FIG. 3, the same reference numerals are applied to the same parts as those of FIG. 8, and the overlapping description will be omitted. The reference numerals 104, 105 designate relay servers, 141 a communication unit, and 142 a control unit. The relay server 104 is connected to the Internet 3, and has the global IP address. The relay server 104 is capable of carrying out the communication with various network apparatus via the Internet 3 by using the global IP address.

The relay server 104 can be constructed so as to include the communication unit 141, the control unit 142, or the like. The communication unit 141 is capable of carrying out the communication with a plurality of network apparatus via the Internet 3.

The control unit 142 receives the login demand transmitted from the network apparatus via the communication unit 141, and secures the communication path by maintaining the connection with the network apparatus. Moreover, when the login is demanded, the control unit 142 receives the designation of various attributes information transmitted from the network apparatus, and carries out the processing of the login by following the attributes information. The attributes information can include the information of whether or not to carry out a cipher communication. Moreover, when it is indicated to carry out the cipher communication, a usable encrypting method can be included in the attributes. Further, the attributes information received at the time of the login which includes the information of whether or not to carry out the cipher communication may be notified to a part of or all of other network apparatus by following the attributes information in the same manner. The designation of this notification at this time, for example, is as follows:

(1) the attributes information is notified to all users;

(2) the attributes information is not notified to any user;

(3) the attributes information is notified to specific users; or

(4) the attributes information is not notified to specific users.

Moreover, when the relay server receives the login demand, and the communication path is secured in the manner stated above, the communication path is maintained until the logout. Then, when receiving the connection demand information from the network device which is connected such that the communication can be carried out, by following the connection demand information, the control unit 142 relays the data forwarding between the network apparatus that is connected capable of carrying out the communication and the network device which demanded the connection. At this time, in the case at the time the network apparatus makes the login, the relay server receives the attributes information to the effect that the cipher communication is carried out, designation is made such that the cipher communication is carried out between this network apparatus and another network apparatus which carried out connection demand to this network apparatus. Accordingly, each network apparatus encrypts the data, transmits the encrypted data, the relay server forwards the encrypted data, and thereby the cipher communication can be realized between the network apparatus.

For example, under the state in which the terminal 11 and the terminal 21 are connected such that the communication can be carried out, and the communication path is secured, when receiving the connection demand information with the terminal 21 from the terminal 11, the relay server 104 carries out the data forwarding with the terminal 11, also carries out the data forwarding with the terminal 21, and realizes the communication between the terminal 11 and the terminal 21 substantially. The terminal 11 is a network device within the local system 1, and the terminal 21 is a network device within the local system 2. The connection can be made from the relay server 104 to the gateway 13 and the gateway 23, but the connection cannot be made to the terminal 11 or the terminal 21. Moreover, as described above, the communication cannot be carried out directly between the terminal 11 and the terminal 21. However, by using the global IP address of the relay server 104, the connection can be made from the terminal 11 to the relay server 104 via the gateway 13, and from the terminal 21 to the relay server 104 via the gateway 23. Therefore, by demanding the login from the terminal 11 or the terminal 21 to the relay server 104, and securing the communication path, the communication can be carried out in both directions between the relay server 104 and the terminal 11 which demanded the connection, and between the relay server 104 and the terminal 21 which demanded the connection.

In the case the communication can be carried out in both directions between the relay server 104 and the terminal 11, and between the relay server 104 and the terminal 21 as in the manner stated above, when the relay server 104 receives the communication demand to the terminal 21 from the terminal 11, the relay server 104 receives the data transmitted from the terminal 11, and transmits the received data to the terminal 21. Accordingly, the relay server 104 carries out the data forwarding from the terminal 11 to the terminal 21. On the other hand, the relay server 104 is capable of receiving the data transmitted from the terminal 21 and transmitting the received data to the terminal 11. In such a manner, the communication can be realized between the terminal 11 and the terminal 21. Moreover, a plurality of connections can be secured with one network device, and by using a plurality of connections, the communication can be carried out with a plurality of network devices. In addition, by using the connections with a plurality of network devices, the relay server is capable of carrying out broadcasting.

Furthermore, in the case of carrying out such communication between the terminals, a network outside the local system is to be used for the communication between the gateway 13 and the relay server 104, and between the gateway 23 and the relay server 104, and as a result, the security is not guaranteed. Therefore, there are cases in which the cipher communication is demanded. When carrying out the cipher communication under a relay protocol level, the cipher communication can be realized between the relay server 104 and the network apparatus. However, when carrying out the communication between the terminals as in the manner stated above, even if one of the terminals carries out the cipher communication, the security cannot be guaranteed under the state in which the other terminal does not carry out the cipher communication. Therefore, when the party carries out a connection demand to the network device which has made the designation that the cipher communication should be carried out, the relay server instructs the party to carry out the cipher communication. Furthermore, when the relay server receives a connection demand to the party from the network device which has made the designation that the cipher communication should be carried out, the relay server instructs the party to carry out the cipher communication.

For example, in the case the terminal 21 intends to carry out the cipher communication with another network apparatus, when the terminal 21 makes the login to the relay server 104, the cipher communication is designated as a part of the attributes information. Then, for example, in the case of trying to carry out the communication by establishing the connection from the terminal 11 to the terminal 21, the relay server 104 designates the cipher communication to the terminal 11 after receiving the connection demand information with the terminal 21 from the terminal 11. Following this designation, the terminal 11 carries out the cipher communication with the relay server 104. Moreover, the relay server 104 carries out the cipher communication with the terminal 21, and realizes the cipher communication between the terminal 11 and the terminal 21 substantially. At this time, by carrying out the encrypting under the relay protocol level as in the manner stated above, the terminal 11 and the terminal 21 are capable of carrying out the cipher communication under the same predetermined encrypting method, without depending on the data to be forwarded. Further, depending on the encrypting method, the relay server 104 can carry out the processing of decrypting and re-encrypting.

In addition to that, for example, in the case the communication is carried out by establishing the connection from the terminal 21 to the terminal 11, since the cipher communication has been already designated at the time of the login, the relay server 104 transmits the connection demand information to the terminal 11 which is the connection destination, and designates the cipher communication to the terminal 11. Following this, the terminal 11 can carry out the cipher communication with the relay server 104.

Moreover, the encrypting can be carried out under application level. In this case, the processing of encrypting and decrypting is carried out under the application of the network apparatus (for example, terminal 11 and terminal 21) which carry out the communication, and under the relay protocol level, no matter whether or not it is the encrypted data, the processing of forwarding is carried out uniformly. The relay server designates the cipher communication, but in addition to that, the relay server 104 only carries out the forwarding processing, and does not carry out processing of decrypting or re-encrypting to the data to be forwarded. In the case of carrying out the cipher communication under the application level as in the manner stated above, an encrypting method can be selected for each application, then encrypting is carried out, and the encrypted data can be forwarded. Moreover, options may include the case in which the encrypting is not performed. For example, the ID encrypting method such as ID-NIKS4 which uses the user ID can be used as the encrypting method. Of course, other various encrypting methods can also be used.

Furthermore, in the abovementioned example, at the time of the login to the relay server 104, the attributes information is transmitted showing whether or not to carry out the cipher communication, but the present invention is not limited to such a case, and for example, the designation that the cipher communication should be carried out can be registered in the relay server 104 in advance, so that it is not necessary to carry out the designation at the time of the login. In the case the designation that the cipher communication should be carried out is registered in the relay server 104 in advance, exchanging of information or data is carried out by performing encrypting of the communication protocol itself which is used for communication with the relay server. Accordingly, the transmission of various information to the relay server 104 can be carried out by the cipher communication.

Furthermore, by making the login to the relay server without indicating the cipher communication, the cipher communication can be indicated when the network apparatus carried out the connection demand. In this case, the relay server 104 notifies, to the connection destination, that the cipher communication has been indicated when notifying that the connection has been demanded, and then, the cipher communication can be carried out with the relay server.

Further, for example, in the case the connection destination is indicating the cipher communication, but the party which has made the connection demand cannot deal with the cipher communication, the connection can be rejected, or the connection destination can be notified that there has been the connection demand from the party which is unable to carry out the cipher communication, and the connection destination may send back a reply concerning whether or not the connection is accepted. Moreover, the same manner can be applied to the case in which the party makes the connection demand, but the connection destination cannot deal with the cipher communication.

The relay server 105 shown in FIG. 3 has the same structure as the relay server 104. By securing the communication paths with the relay server 104 and with the relay server 105, the communication can be realized between the network device which made the login to the relay server 104 and the network device which made the login to the relay server 105. In this case, when the connection destination or the origin of the connection demand is demanding the cipher communication, by notifying, to the other side, the fact that the cipher communication is demanded, by either one of the relay servers, the cipher communication can be realized. In addition, more relay servers can be present over the Internet 3, and the relay server for relaying the communication between the relay servers can be present. The number of relay servers present on the Internet is random, and it is necessary for at least one relay server to be present.

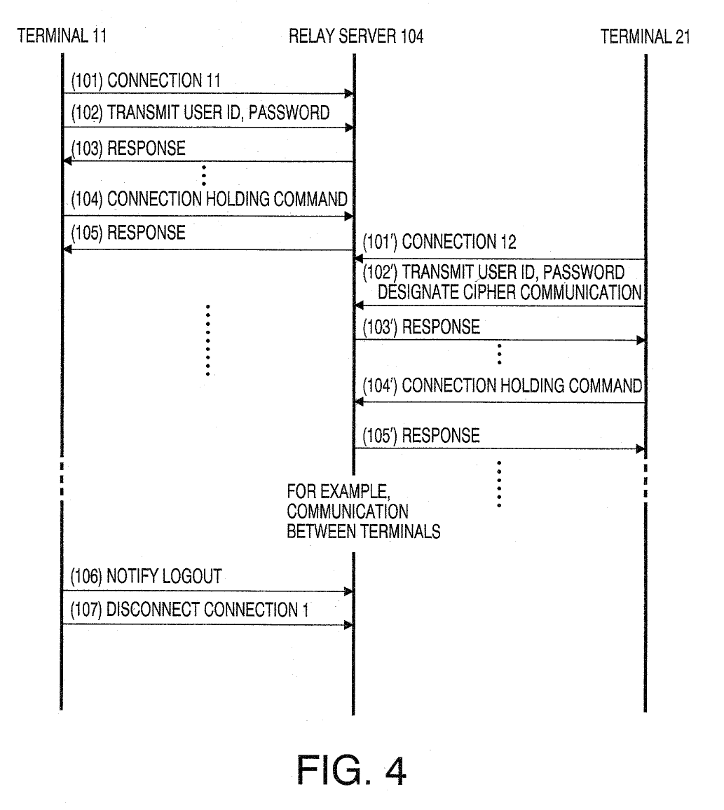

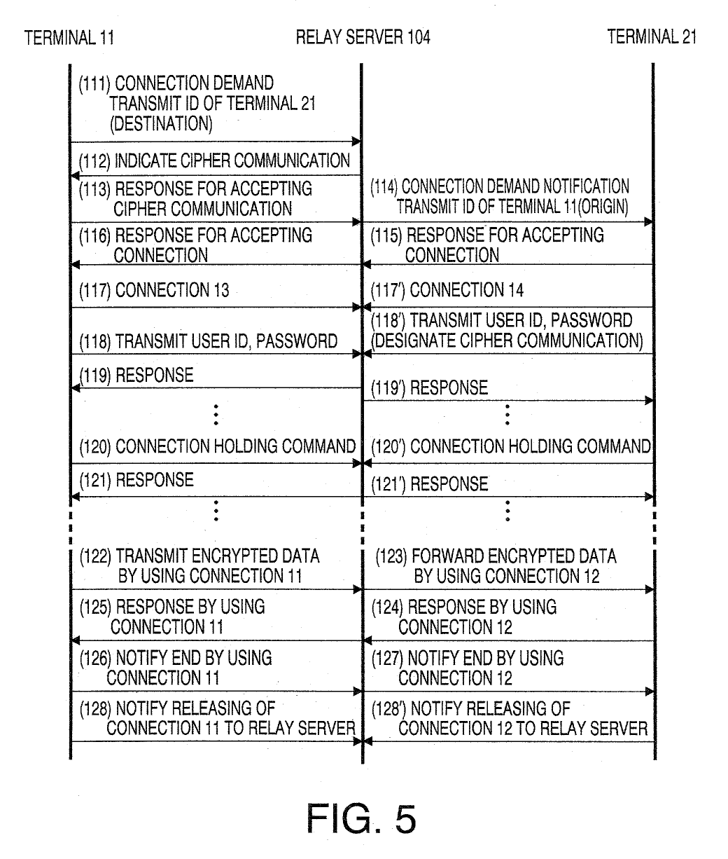

The communication procedures shown in FIG. 4 and FIG. 5 are carried out by using TCP/IP, and the connection with the relay server, the continuation of the connection, the connection demand to the terminal, the data forwarding to the terminal, the end of the connection with the terminal, the end of the connection with the relay server, and so forth are carried out. FIG. 4 shows the connection with the relay server 104, the continuation of the connection, and the end of the connection with the relay server 104. FIG. 5 shows the connection demand from the terminal, the data forwarding to the terminal, the end of the connection with the terminal, and so forth.

As an example, it is assumed that the communication is carried out between the terminal 11 within the local system 1 and the terminal 21 within the local system 2 which are shown in FIG. 3, and in this example, the terminal 21 demands the cipher communication at the time of the login. The terminal 11 and the terminal 21 are registered as users in the relay server 104 in advance. For example, the user ID at the time of the login or the password for the authentication may be registered as the information of registration.

After being started or by the instruction of the operator, in (101), the terminal 11 makes the connection to the relay server 104 via the gateway 13, makes the login to the relay server 104, and establishes the TCP/IP connection (connection 11) with the relay server 104. Since the terminal 11 is the network apparatus within the local system 1, the communication cannot be carried out directly from the relay server 104, but by the login from the terminal 11 which is the client, the connection can be made to the relay server 104. Since the TCP/IP connection is capable of carrying out the data communication in both directions, the communication can be carried out from the terminal 11 to the relay server 104, or from the relay server 104 to the terminal 11.

After the connection 11 is established, the terminal 11 transmits the user ID and the password to the relay server 104 in (102). The relay server 104 examines whether or not the received user ID and the password are held as the connection information in the control unit 142, and the carries out the authentication of the terminal 11. By the authentication, the connection with an unspecified third party can be avoided, and the safety can be secured. In the case of a failure of the authentication in that the connection information is not registered or in that the password is incorrect, the relay server 104 carries out the negative response to the terminal 11, or disconnects the connection 11. In the case the authentication succeeds, the relay server 104 carried out the positive response in (103).

Moreover, during the login processing up to this stage, various attributes information can be designated when necessary. As the attributes information, it is possible to designate whether or not to carry out the cipher communication. Besides this designation, if necessary, it is possible to designate various attributes information such as, for example, the information concerning whether or not to notify, to other users, various information including the fact of the completion of the login, the information concerning the receiving of the data, and/or the information concerning the destination capable of being connected. The attributes information may be transmitted to the relay server 104 along with the user ID, the password, and/or the like. Alternatively, after the positive response is carried out from the relay server 104, the transmission of the attributes information may be carried out separately.

As in the manner stated above, after the processing at the time of the login is completed, until the connection 11 is disconnected, the connection 11 is controlled to be continued. For this reason, the terminal 11 transmits the connection holding command to the relay server 104 periodically in (104), and receives the response of the confirmation from the relay server 104 in (105). Accordingly, the connection is held, and it is confirmed that the relay server is operating normally.

In the same manner, the terminal 21 makes the connection to the relay server 104 via the gateway 23, makes the login, and establishes the TCP/IP connection (connection 12) with the relay server 104 in (101′). Since the terminal 21 is also the network device within the local system 2, the communication cannot be carried out directly from the relay server 104, but the connection can be made to the relay server 104 by the login from the terminal 21 which is the client. By the connection 12, the communication can be carried out from the terminal 21 to the relay server 104, and from the relay server 104 to the terminal 21.

After the connection 12 is established, the terminal 21 transmits the user ID and the password to the relay server 104 in (102′). The relay server 104 examines whether or not the received user ID and the password are held as the connection information in the control unit 142, and also carries out the authentication of the terminal 21. In the case of a failure of authenticate in that the connection information is not registered or in that the password is incorrect, the relay server 104 carries out the negative response to the terminal 21 or disconnects the connection 12. When the authentication succeeds, the relay server 104 carries out the positive response in (103′). During the login processing up to this stage, various attributes information can be designated. In this example, it is assumed that the terminal 21 carries out the cipher communication, and the fact that the cipher communication is to be carried out is notified as the attributes information. Further, the attributes information can be transmitted to the relay server 104 along with, for example, the user ID and/or the password, or after the positive response is carried out from the relay server 104, the transmission of the attributes information can be carried out separately.

When the processing at the time of the login is completed as in the manner stated above, until the connection 12 is disconnected, the connection 12 is controlled to be continued. Therefore, the terminal 21 transmits the connection holding command to the relay server 104 periodically in (104′), and obtains the response of confirmation from the relay server 104 in (105′). In this manner, the connection is held, and it is confirmed that the relay server is operating normally.

Further, in the example shown in FIG. 4, the login to the relay server 104 by the terminal 11 is carried out before the login by the terminal 21, but this order may be arbitrary, and the login may be carried out at any time if it is before the communication with the two terminals are carried out. Moreover, it is necessary for the connection with the relay server 104 to be continued until the communication with the two terminals are carried out.

As shown in FIG. 5, when the terminal 11 generates a demand to the effect that the connection with the terminal 21 is to be made, in (111), the terminal 11 designates the user ID of the terminal 21 with which the terminal 11 intends to make the connection, and demands the connection to the relay server 104. Further, the user ID of the terminal 21 which is the connection destination can be designated by any methods. For example, the user ID may be obtained in advance, or the user ID may be designated by confirming it by obtaining, from the relay server 104, the list or the like of users which are in the login state. The relay server 104 returns an error message to the terminal 11 in the case the terminal 21 corresponding to the designated user ID is not in the login state.

When the terminal 21 is in the login state, the connection and the communication with the terminal 21 can be carried out. In this example, since the designation that the cipher communication should be carried out has been made by the terminal 21, the relay server 104 designates the cipher communication to the terminal 11 in (112). In the case the terminal 11 is capable of carrying out the cipher communication, in (113), the terminal 11 returns the response for accepting the cipher communication. After confirming this response, the relay server 104 transmits, to the terminal 21, the connection demand notification including the information of the fact that there is the connection demand from the terminal 11 to the terminal 21 and including the user ID of the terminal 11 which is demanding the connection in (114).

Further, in the case the terminal 11 is unable to carry out the cipher communication, the connection demand from the terminal 11 and the connection with the terminal 21 are not carried out. Moreover, in this example, the connection demand is notified from the terminal 11 to the terminal 21 after waiting for the response from the terminal 11 to the effect that the terminal 11 accepts the cipher communication, but the present invention is not limited to such a case, and the connection demand notification to the terminal 21 can be carried out at the same time the indication of the cipher communication is notified to the terminal 11.

The terminal 21 stores that the connection used for the transmission of the connection demand notification is used in the connection with the terminal 11, and in (115), the terminal 21 returns the response for accepting the connection. At this time, the terminal 21 is set so as to carry out the cipher communication with the terminal 11 through the connection 12. Further, in the case of rejecting the connection, for example, the terminal 21 can return an error massage.

The relay server 104 returns the response from the terminal 21 to the terminal 11 in (116). When the response from the terminal 21 is a response for accepting the connection, the relay server 104 stores that the connection 11 is to be used in the communication with the terminal 11, and the connection 12 is to be used in the communication with the terminal 12. In addition, at this time, the relay server 104 stores that the connection 11 and the connection 12 are to be used for the cipher communication.

Moreover, when receiving the response that the connection can be accepted, the terminal 11 which received the response from the terminal 21 stores that the connection in use (connection 11) is to be used for the communication with the terminal 21. At this time, the terminal 11 is set so as to carry out the cipher communication with the terminal 21 through the connection 11.

After setting the cipher communication to be carried out between the terminal 11 and the relay server 104, and between the terminal 21 and the relay server 104, the data is transmitted by the cipher communication actually after (122). Further, in the example shown in FIG. 5, after it is determined that the communication is to be carried out between the terminal 11 and the terminal 21, each of the terminal 11 and the terminal 21 establishes a new TCP/IP connection to the relay server 104 in order to receive the connection demand from other network apparatus, or in order to carry out the connection demand to other network apparatus. That is, the terminal 11 makes the login to the relay server 104, and establishes the TCP/IP connection (connection 13) with the relay server 104 in (117), and the terminal 11 transmits the user ID and the password to the relay server in (118). In addition, if necessary, the terminal 11 transmits the attributes information to the relay server 104 in (118). The relay server 104 carries out the authentication of the terminal 11 by the received user ID and password, and in (119), returns the response. Then, the terminal 11 transmits the connection holding command to the relay server 104 periodically in (120) to maintain the connection 13, and the relay server 104 returns the response to the terminal 11 in (121).

In the same manner, the terminal 21 makes the login to the relay server 104, and establishes the TCP/IP connection (connection 14) with the relay server 104 in (117′), and the terminal 21 transmits the user ID and the password to the relay server 104 in (118′). In addition, if necessary, the terminal 21 transmits the attributes information to the relay server 104 in (118′). In this example, the information that the cipher communication is to be carried out is transmitted as the attributes information. The relay server 104 carries out the authentication of the terminal 21 by the received user ID and password, and in (119′), returns the response. Moreover, the relay server 104 is set such that the communication with the terminal 21 is to be carried out under the cipher communication. Then, the terminal 21 transmits the connection holding command to the relay server 104 periodically in (120′) to maintain the connection 14, and the relay server 104 returns the response to the terminal 21 in (121′).

Further, the attributes information to be designated when the new TCP/IP connection is established in the manner stated above may be different from the attributes information of the previous connection. Moreover, the connection on this occasion may inherit the attributes information of the previous connection without designating the attributes information. Alternatively, the relay server 104 and/or the terminals 11 and 12 may be constructed to enable setting such that the connection on this occasion can inherit the attributes information of the previous connection, depending on the attribute information. In addition, in the case it is not necessary to secure the vacant connection as in the manner stated above, the processes (117) to (121) or (117′) to (121′) are not necessary. Furthermore, in the case a plurality of connections have been already secured, it is not necessary to carry out these processes.

By setting that the cipher communication to be carried out between the terminal 11 and the relay server 104 and between the terminal 21 and the relay server 104 in the processes (111) to (116), the cipher communication can be carried out between the terminal 11 and the terminal 21. For example, in the case of transmitting the data from the terminal 11 to the terminal 21, the terminal 11 encrypts the data to be transmitted, and in (122), the terminal 11 transmits the encrypted data to the relay server 104 through the connection 11. Further, in this example, it is assumed that the processing of encrypting is carried out under the relay protocol level.

The relay server 104 receives the encrypted data from the terminal 11, decrypts the received data, and then re-encrypts the data so that the data can be decrypted by the terminal 21. In (123), the relay server 104 transmits the data to the terminal 21 through the connection 12. Moreover, there are cases in which the processing of decrypting and re-encrypting is not necessary, depending on an encrypting method, and in such cases, the relay server 104 can relay the data as it is.

The terminal 21 receives the encrypted data from the terminal 11 which is transmitted through the connection 12 from the relay server 104, decrypts the data to obtain the original data. Subsequently, in (124), the terminal 21 transmits the response for the terminal 11 to the relay server 104. The relay server 104 receives the response to the terminal 11 from the terminal 21, and in (125), transmits the received response to the terminal 11 through the connection 11.

As in the manner stated above, by using the connection 11 between the terminal 11 and the relay server 104, and the connection 12 between the terminal 21 and the relay server 104 and by relaying the data by the relay server 104, the cipher communication can be carried out between the terminal 11 and the terminal 12. Further, the data forwarding from the terminal 11 to the terminal 21 by (122) to (125) can be repeated several times. Moreover, the data forwarding from the terminal 21 to the terminal 11 can be carried out in the same manner. That is, the relay server 104 can receive the data encrypted by the terminal 21, and when necessary, the relay server 104 carries out the processing of decrypting and re-encrypting on the data, and then transmits the data to the terminal 11.

When the data forwarding between the terminal 11 and the terminal 21 is completed, the end notification is carried out from the terminal 11 or the terminal 21. In this example, it is assumed that the end notification is carried out from the terminal 11, and in (126), the terminal 11 transmits the end notification for the terminal 21 to the relay server 104 through the connection 11. The relay server 104 transmits the end notification for the terminal 21 which is received from the terminal 11, to the terminal 21 through the connection 12 in (127). The terminal 11 which transmitted the end notification transmits the releasing notification indicating that the connection 11 has become vacant, to the relay server 104 in (128). Moreover, the terminal 21 which received the end notification also transmits the releasing notification indicating that the connection 12 has become vacant, to the relay server 104 in (128′). Accordingly, the relay server 104 stores that the connection 11 and the connection 12 are not used for the communication with the terminal 11 and the terminal 21, and that the connections have become vacant. Further, in this example, the response to the end notification is not carried out, but the response may be sent back.

The connection 11 and the connection 12 which are released in the manner stated above are maintained by performing the connection holding command and its response periodically as shown in (104), (105), or (104′), (105′) of FIG. 4. In this manner, it is possible to maintain the connections between the terminal 11 and the relay server 104 and between the terminal 21 and the relay server 104. Further, the connection 11 and the connection 13 are secured between the terminal 11 and the relay server 104 at this time. In addition, the connection 12 and the connection 14 are secured between the terminal 21 and the relay server 104. The connections may be continued, or when the connection 11 and the connection 12 are released, these connections may be disconnected. Moreover, the connection 11 and the connection 12 may be continued, and the connection 13 and the connection 14 may be disconnected.

Returning to FIG. 4, for example, in the case the terminal 11 shuts the power source, or in the case of ceasing the connection to the relay server 104, in (106), the terminal 11 notifies the logout to the relay server 104. At this time, in the case a plurality of connections are secured, the notification of the logout can be carried out through any connection. Subsequently, the terminal 11 disconnects all connections, and the procedure is terminated. In this example, the connection 11 is disconnected, and the procedure is terminated in (107). In the case the connection 13 is reserved by (117) to (119) of FIG. 5, the connection 13 is also disconnected. The relay server 104 receives the notification of the logout from the terminal 11, recognizes the logout of the terminal 11, and disconnects all connections with the terminal 11. Further, the same processes are applied for the terminal 21.

By carrying out the abovementioned procedure, even in the case both of or one of the network apparatus is located within the local systems or the local system, the communication can be carried out. Furthermore, by designating the cipher communication in advance, the relay server 104 can designate the cipher communication to the destination, the cipher communication can be carried out between each terminal and the relay server 104, and the cipher communication can be realized between the terminals.

Further, the procedure for carrying out the connection with the relay server 104, the continuation of the connection, the connection demand to the terminal, the data forwarding to the terminal, the end of the connection with the terminal, and the end of the connection with the relay server can be made so as to give maintained permeability to and no influence to the command or the data exchanged by the application protocol working in an upper stage. Furthermore, the communication can be carried out by using the existing application protocol as it is. Moreover, by carrying out the processing of encrypting and decrypting in the manner stated above under the relay protocol level, it is possible to carry out the cipher communication without depending on the application.

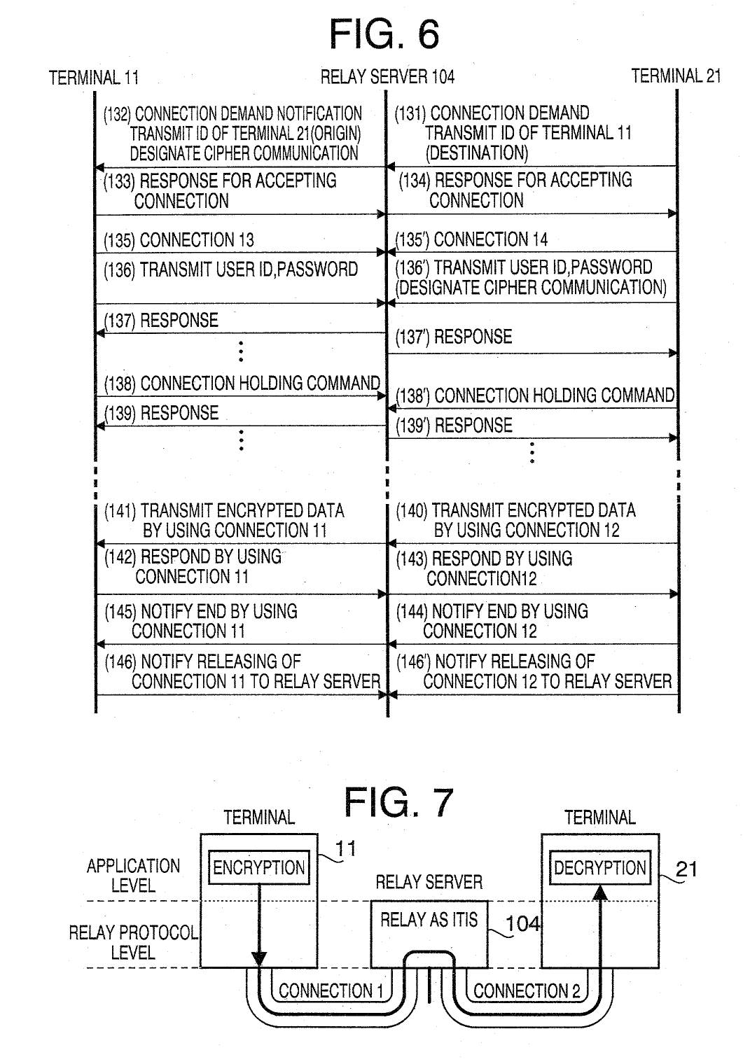

FIG. 5 shows an example of the communication procedure in the case the connection demand is carried out from the terminal 11 to the terminal 21. On the other hand, FIG. 6 shows an example of the communication procedure when carrying out the connection demand to the terminal 11 from the terminal 21 which is indicating the cipher communication.

When demanding the connection from the terminal 21, in (131), the terminal 21 carries out the connection demand to the relay server 104 by designating the user ID of the terminal 11. At this time, since the cipher communication has been already designated at the time of the login, it is assumed that the cipher communication is to be carried out with the destination even without demanding the cipher communication again. However, the cipher communication can be designated again. In (132), the relay server 104 transmits the connection demand notification including the information that there is the connection demand from the terminal 21 to the terminal 11 and including the user ID of the terminal 21 which is demanding the connection. At this time, the relay server 104 indicates the cipher communication to the terminal 11.

The terminal 11 which received the connection demand notification stores that the connection 11 used for the transmission of the connection demand notification is used for the communication with the terminal 21, and carries out the setting such that the cipher communication is to be carried out. Subsequently, in (133), the terminal 11 returns the response for accepting the connection. Further, in the case the terminal 11 rejects the connection or in the case the terminal 11 cannot carry out the cipher communication, for example, the terminal 11 returns an error message.

When receiving the response for accepting the connection from the terminal 11, in (134), the relay server 104 returns the response from the terminal 11 to the terminal 21. In the case the response from the terminal 11 is a response for accepting the connection, the relay server 104 stores that the connection 11 is to be used for the communication with the terminal 11, and that the connection 21 is to be used for the communication with the terminal 21. In addition to that, at this time, the relay server 104 stores that the connection 11 and the connection 12 are to be used for the cipher communication.

Moreover, in the case of receiving the response for accepting the connection, the terminal 21 which received the response from the terminal 11 stores that the connection in use (connection 12) is to be used for the communication with the terminal 11. In this case, the terminal 21 carries out the cipher communication with the terminal 11 through the connection 12.

After making setting that the cipher communication is carried out between the terminal 11 and the relay server 104, and between the terminal 21 and the relay server 104 as in the manner stated above, the data is to be transmitted by the cipher communication actually after (140). Further, in the example shown in FIG. 6, the connection 13 is provided between the terminal 11 and the relay server 104 by (135) to (139), and the connection 14 is provided between the terminal 21 and the relay server 104 by (135′) to (139′).

The procedure when forwarding the data is the same as the example shown in FIG. 5, but in the example of FIG. 6, the data is forwarded from the terminal 21 to the terminal 11. The terminal 21 encrypts the data to be transmitted, and in (140), transmits the encrypted data to the relay server 104 through the connection 12. The relay server 104 receives the encrypted data from the terminal 21, and after decrypting and re-encrypting the received data when necessary, in (141), the relay server 104 transmits the encrypted data to the terminal 11 through the connection 11. The terminal 11 receives the encrypted data from the terminal 21, which is transmitted from the relay server 104 through the connection 11, and decrypts the encrypted data to obtain the original data. Then, in (142), the terminal 11 transmits the response for the terminal 21 to the relay server 104. The relay server 104 receives the response to the terminal 21 from the terminal 11, and in (143), transmits the received response to the terminal 21 through the connection 12.

As in the manner stated above, also in the case for carrying out the connection demand from the terminal 21 which has designated the cipher communication in advance, the cipher communication can be carried out with the terminal 11. Further, in such a case, the data also can be forwarded from the terminal 11 to the terminal 21, and in addition to that, the data may be forwarded several times.

Moreover, when the data forwarding is ended between the terminal 11 and the terminal 21, the same processes as the example shown in FIG. 5 can be adopted, and in the example shown in FIG. 6, the terminal 21 transmits the end notification to the relay server 104 through the connection 12 in (144), and the relay server 104 transmits the end notification received from the terminal 21 to the terminal 11 through the connection 11 in (145). Then, the terminal 11 can notify the releasing of the connection 11 to the relay server 104 in (146), and the terminal 21 can notify the releasing of the connection 12 to the relay server 104 in (146′).

Further, in two examples described in the above-mentioned communication procedure, the cipher communication is carried out only on the data to be forwarded. However, the present invention is not to be limited to such a case. For example, after designating the cipher communication or after carrying out the response for accepting the cipher communication, it is possible to carry out the communication by encrypting the protocol itself. Furthermore, by registering in advance, the cipher communication can be carried out from the time the login is made.

In the case of the abovementioned communication procedure, the processing of encrypting and decrypting is carried out under the relay protocol level. However, the present invention is not to be limited to such case, and for example, the processing can be carried out under the application level as shown in FIG. 7. For example, in FIG. 7, the data is forwarded by the cipher communication to the terminal 21 from the terminal 11 via the relay server 104.

In this case, for example, the cipher communication is designated from the relay server 104 to the terminal 11. Accordingly, the designation of the cipher communication is received under the relay protocol level of the terminal 11, and the indication is communicated to the application or further to the user of the terminal 11.

The terminal 11 encrypts the data to be forwarded, by the application which formed the data, or by another application, and waits for the transmission. The encrypted data is forwarded to the relay server 104 in the same manner as the case in which the data is not encrypted under the relay protocol level. The relay server 104 relays the encrypted data transmitted from the terminal 11 by forwarding the data to the terminal 21 as it is. The terminal 21 receives the encrypted data as it is under the relay protocol level, and by decrypting under the application level, plain text (original data) or the like can be obtained.

In this manner, by carrying out the processing of encrypting and decrypting by the application level, the cipher communication can be realized between the terminals via the relay server 104. In the case of carrying out the cipher communication under the application level, the encrypting method can be changed in accordance with the application to be used, or it is possible to determine whether or not to carry out the cipher communication, in accordance with the application to be used. Moreover, as in the manner stated above, the relay server 104 can forward the data transmitted from the terminals as it is, and there is an advantage in that the relay server need not carry out the processing of encrypting and decrypting.

Moreover, both the encrypting under the application level and the encrypting under the relay protocol level can be used together. In such a case, even when carrying out the decrypting processing under the relay protocol level in the relay server 104, since the data has been encrypted under the application level, the security can be improved against hacking or the like to the relay server 104.

In each of the examples shown above, the designation for carrying out the cipher communication is made at the time of the login, when demanding the connection, or in advance. However, the present invention is not limited to such a case, and after the login is made, even before the communication or during the communication, the change concerning designation of the cipher communication can be made at any time.

Furthermore, in each of the examples described above, the communication is carried out between the network apparatus which made the login to the same relay server. However, the present invention is not limited to such a case. For example, as shown in FIG. 3, the communication can be carried out between the network apparatus which made the login to the relay server 104 and the network apparatus which made the login to the relay server 105. In this case, if the communication is carried out under the relay protocol level, the cipher communication is carried out between the relay server 104 and the relay sever 105, and thereby, it is possible to realize the cipher communication between the network apparatus. Of course, the cipher communication can be carried out under the application level.

What is claimed is:

1. A relay server comprising:
communication means for carrying out communication with a plurality of network devices; and
control means for relaying communication between the network devices by using the communication means,
wherein the control means starts communication with one network device of the plurality of network devices by a login demand from the one network device, and carries out relay processing in accordance with attributes information which has been designated by the one network device when the one network device makes login to the relay server.

2. The relay server according to claim 1, wherein the control means receives, as the attributes information, information concerning notification to other network devices of the plurality of network devices, and contents of the notification include fact that the one network device which has designated the attributes information has made the login.

3. The relay server according to claim 1, wherein the control means receives, as the attributes information, information concerning data receiving of the one network device which has designated the attributes information.

4. The relay server according to claim 1, wherein the control means receives, as the attributes information, information concerning authentication for the one network device which has designated the attributes information, and carries out the authentication when another of the plurality of network devices demands a connection to the one network device.

5. The relay server according to claim 1, wherein the control means receives, as the attributes information, information concerning other network devices of the plurality of network devices which can carry out communication with the one network device which has designated the attributes information.

6. A relay system comprising:
a plurality of network devices which are located in local systems; and
a relay server for carrying out communication with the plurality of network devices,
wherein the relay server carries out relaying of data between a first network device and a second network device of the plurality of network devices in accordance with a connection demand to the first network device which is received from the second network device, and the first network device carries out authentication of the second network device based on data which is transmitted from the second network device and relayed by the relay server, and a local system of said local systems within which the first network device is located is different from a local system of said local systems within which the second network device is located.

7. The relay system according to claim 6, wherein the first network device carries out the authentication by using each authentication method corresponding to each application to be used.

8. A relay server comprising:
communication means for carrying out communication with a plurality of network devices; and
control means for relaying communication between the network devices by using the communication means,
wherein if cipher communication is designated by a first network device of the plurality of network devices, the control means indicates the cipher communication to a second network device of the plurality of network devices which has demanded a connection to the first network device.

9. A relay server comprising:
communication means for carrying out communication with a plurality of network devices; and
control means for relaying communication between the network devices by using the communication means,
wherein if cipher communication is designated by a first network device of the plurality of network devices, the control means indicates the cipher communication to a second network device of the plurality of network devices when the first network device demands a connection to the second network devices.

10. The relay server according to claim 8, wherein the cipher communication is carried out under a relay protocol level.

11. The relay server according to claim 9, wherein the cipher communication is carried out under a relay protocol level.

12. The relay server according to claim 8, wherein when the relay server carries out communication with the network device which has been set in advance so as to carry out the cipher communication, the control means carries out the communication with the network device by encrypting a protocol itself as well.

13. The relay server according to claim 9, wherein when the relay server carries out communication with the network device which has been set in advance so as to carry out the cipher communication, the control means carries out the communication with the network device by encrypting a protocol itself as well.

14. The relay server according to claim 8, wherein the cipher communication is carried out under an application level of the network devices.

15. The relay server according to claim 9, wherein the cipher communication is carried out under an application level of the network devices.

16. The relay server according to claim 8, wherein the cipher communication is carried out both under a relay protocol level and under an application level of the network devices.

17. The relay server according to claim 9, wherein the cipher communication is carried out both under a relay protocol level and under an application level of the network devices.

18. The relay server according to claim 8, wherein when the first network device makes login to the relay server, the control means receives, from the first network device, designation of whether or not the cipher communication is to be carried out.

19. The relay server according to claim 9, wherein when the first network device makes login to the relay server, the control means receives, from the first network device, designation of whether or not the cipher communication is to be carried out.

20. The relay server according to claim 19, wherein the control means notifies the designation of whether or not the cipher communication is to be carried out to other network devices of the plurality of network devices.
